(19) United States
(12) Patent Application Publication
(10) Pub. No.: US 2004/0021919 A1
(43) Pub. Date: Feb. 5, 2004

(54) Focal adjustable hologram lens and optical apparatus using the same

(75) Inventor: Jong-soo Lee, Cheonan-si (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/429,250

(22) Filed: May 5, 2003

(30) Foreign Application Priority Data
May 3, 2002 (KR) 2002-24436

(51) Int. Cl. G02B 5/32

(52) U.S. Cl. 359/15

(57) ABSTRACT

Provided is a hologram lens including a holographic plate and first and second electrodes. The holographic plate is formed of a material having a refractive index which varies according to an electro-optic effect and has a hologram recorded thereon to serve as a lens. First and second electrodes are formed on front and back surfaces of the holographic plate to apply an electrical field to a hologram area of the holographic plate in which at least the hologram is recorded. A focal point is adjusted depending on the strength of the electrical field applied to the hologram area. Accordingly, a hologram lens can be made of a material having a variable refractive index and recording a hologram thereon so that the hologram lens serves as a lens. Thus, in the hologram lens, a focal point can vary depending on the strength of an electrical field applied to a hologram area.

### BACKGROUND OF THE INVENTION

This application claims the priority of Korean Patent Application No. 2002-24436, filed May 3, 2002, in the Korean Intellectual Property Office, the disclosure of which is incorporated herein in its entirety by reference.

1. Field of the Invention

The present invention relates to a focal adjustable hologram lens which does not need to move to adjust a focal point and an optical apparatus using the same.

2. Description of the Related Art

FIG. 1 illustrates a general condensing lens. A general optical apparatus includes a lens system having at least one or more lenses and needs to adjust the position of focal points of the lenses. As shown in FIG. 1, a condensing lens 1 has to be mechanically moved a distance d by a mechanism (e.g., using a driving power of a motor or an electromagnet) to vary a focal length f0 of the condensing lens 1 by a distance d.

As described above, an optical apparatus, which includes a lens system having at least one or more lenses and needs to vary the focal points of the lenses, requires a mechanical moving part to vary the focal points of the lenses. Thus, the configuration of the optical apparatus is complicated.

### SUMMARY OF THE INVENTION

Accordingly, the present invention provides a focal adjustable hologram lens, which does not need to move to vary a focal point, and an optical apparatus using the same.

According to an aspect of the present invention, there is provided a hologram lens including a holographic plate and first and second electrodes. The holographic plate is formed of a material having a refractive index which varies according to an electro-optic effect and which records a hologram thereon so as to serve as a lens. The first and second electrodes are formed on the front and back surfaces of the holographic plate so as to apply an electrical field to a hologram area of the holographic plate in which at least the hologram is recorded. A focal point is adjusted depending on the strength of the electrical field applied to the hologram area.

According to another aspect of the present invention, there is provided an optical apparatus including a lens system having at least one or more lenses and adjusting at least one of a focal point and a magnifying power. The lens system includes a holographic plate and first and second electrodes. The holographic plate is formed of a material having a refractive index which varies according to an electro-optic effect and which records a hologram thereon so as to serve as a lens. The first and second electrodes are formed on the front and back surfaces of the holographic plate so as to apply an electrical field to a hologram area of the holographic plate in which at least the hologram is recorded. A focal point is adjusted depending on the strength of the electrical field applied to the hologram area.

The optical apparatus may be used in an optical recording and/or reproducing apparatus and the hologram lens may be used as an objective lens for focusing incident light as a light spot on an optical recording medium, so that a magnetic circuit for adjusting a focal position of the objective lens in a focusing direction is excluded.

It is preferable that the lens system is a zoom lens system, a focal adjustable lens system, a compound lens system of a camera, or a compound lens system of a video camera.

The holographic plate may be formed of a polymer liquid crystal, a dichromated gelatin, a silver-halide emulsion, a photoresist, or a non-linear holographic recording material.

The non-linear holographic recording material may be photopolymer, LiNbO₃, or BSO.

### BRIEF DESCRIPTION OF THE DRAWINGS

The above features and advantages of the present invention will become more apparent by describing in detail exemplary embodiments thereof with reference to the attached drawings in which:

FIG. 1 is a view of a general condensing lens;

FIG. 2 is a schematic view of a focal adjustable hologram lens according to the present invention;

FIG. 3 is a view illustrating an example of manufacturing a holographic plate shown in FIG. 2 by forming a hologram area, in which a hologram serving as a condensing lens is recorded, in the holographic plate;

FIG. 4 is a view illustrating a function of condensation of a light beam of a holographic plate having the hologram area formed as shown in FIG. 3;

FIG. 5 is a view illustrating a lens system having a plurality of lenses according to an embodiment of the present invention; and

FIG. 6 is a view illustrating an example of using a hologram lens according to the present invention instead of one of the plurality of lenses of the lens system shown in FIG. 5.

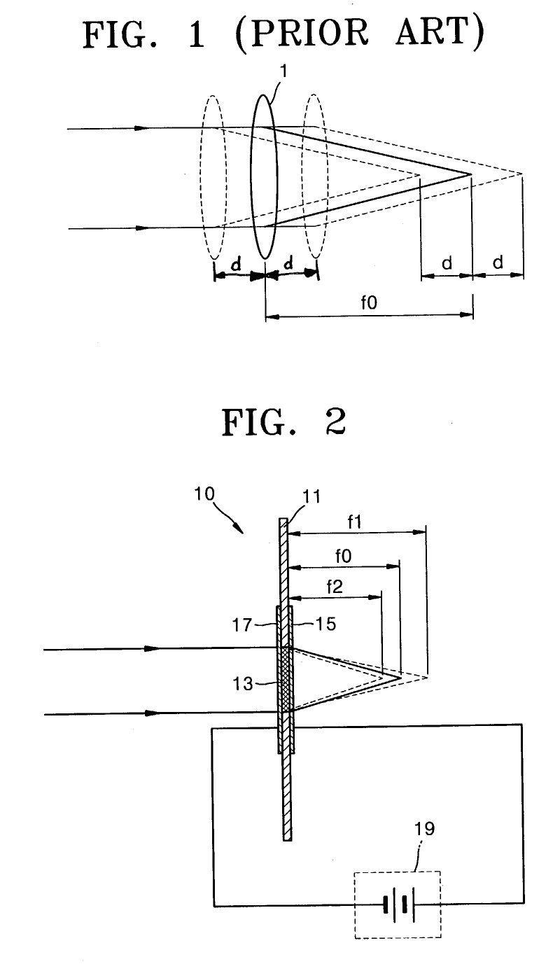

### DETAILED DESCRIPTION OF THE INVENTION

FIG. 2 is a schematic view of a focal adjustable hologram lens according to the present invention. Referring to FIG. 2, a hologram lens 10 includes a holographic plate 11 on which a hologram is recorded to serve as a lens and first and second electrodes 15 and 17. The first and second electrodes 15 and 17 are formed on the front and back surfaces of the holographic plate 11 so as to apply an electrical field to a hologram area 13 in which the hologram of the holographic plate 11 is recorded.

The holographic plate 11 is formed of a material, which has a refractive index which varies according to an electro-optic effect and can record the hologram thereon, and has at least an area in which the hologram is recorded to serve as a lens.

The holographic plate 11, for example, may be made of one of a polymer liquid crystal (PLC), a dichromated gelatin, a silver-halide emulsion, a photoresist, and a non-linear holographic recording material. The non-linear holographic recording material may be photopolymer, LiNbO₃, or BSO.

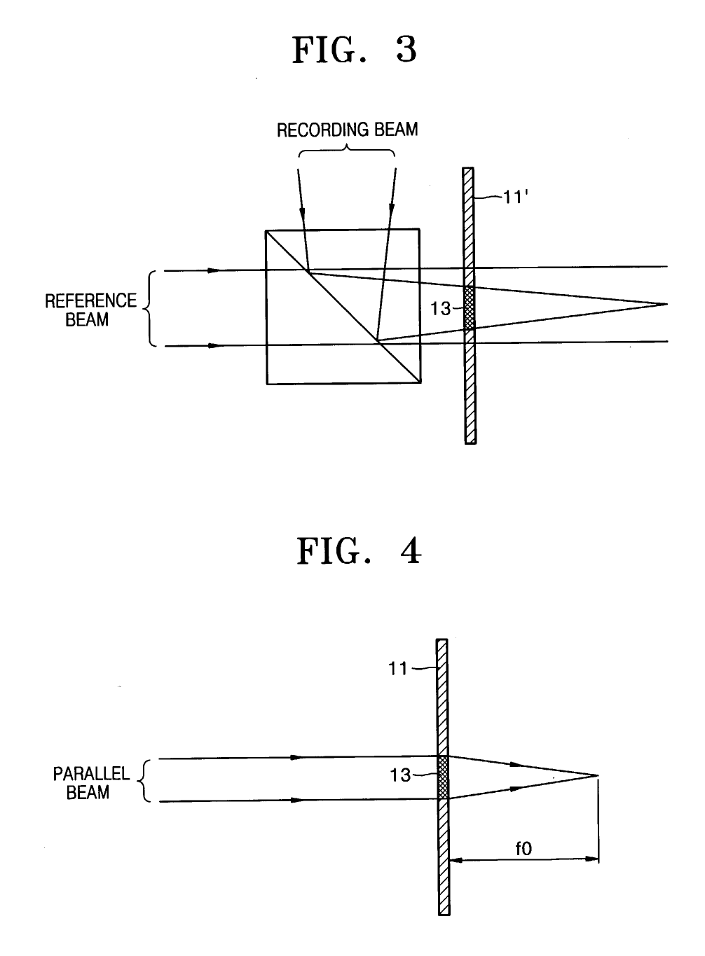

Referring to FIG. 3, a holographic plate 11′, which is made of a material having a refractive index which varies according to an electro-optic effect and capable of recording a hologram thereon, is prepared. A hologram is recorded on the holographic plate 11′ to form a hologram area 13, so that the hologram area 13 serves as a lens. Then, the holographic plate 11 shown in FIG. 2 can be obtained. The hologram lens 10 according to the present invention has the first and second electrodes 15 and 17 to apply an electrical field to the hologram area 13 formed on the front and back surfaces of the holographic plate 11 manufactured as shown in FIG. 3.

FIG. 3 is a view illustrating an example of manufacturing the holographic plate 11 shown in FIG. 2 by forming the hologram area 13, in which a hologram serving as a condensing lens is recorded, in the holographic plate 11′, and FIG. 4 is a view illustrating a function of condensation of light of the holographic plate 11 having the hologram area 13 formed as shown in FIG. 3.

As shown in FIG. 3, when a reference beam having the form of a parallel beam and a recording beam having the form of a convergent light beam are radiated onto the holographic plate 11′, a hologram corresponding to interference according to the phase difference between the reference beam and the recording beam is recorded on the holographic plate 11′.

Referring to FIG. 4, when a parallel beam corresponding to the reference beam presented in FIG. 3 is radiated onto the holographic plate 11 formed by recording the hologram on the holographic plate 11′ as shown in FIG. 3, the parallel beam changes to a focal beam while passing through the hologram area 13 in which the hologram of the holographic plate 11 is recorded.

Here, in FIGS. 2 through 4, the hologram lens 10 serves as a convergent lens. In a case where a hologram is recorded by radiating a recording beam corresponding to a divergent light beam, the hologram lens 10 serves as a divergent lens.

Referring to FIG. 2, the first and second electrodes 15 and 17 are formed on the front and back surfaces of the holographic plate 11 so as to apply an electrical field to the hologram area 13 of the holographic plate 11. It is preferable that the first and second electrodes 15 and 17, for example, are formed of a transparent material, such as ITO, throughout the hologram area 13 of the holographic plate 11. The first and second electrodes 15 and 17 are electrically connected to both nodes of a direct current (DC) power supply 19.

When a DC power is applied to the hologram lens 10, which includes the holographic plate 11, on which the hologram serving as a lens is formed, and the first and second electrodes 15 and 17 form the front and back surfaces of the holographic plate 11, via the first and second electrodes 15 and 17, an electrical field is applied to the hologram area 13. Also, as the DC power increases or decreases, the strength of the electrical field varies and the focal length of the hologram lens 10 is adjusted.

When an electrical field having a reference strength is applied to the hologram area 13, the focal length of the hologram lens 10 is f0. If the strength of the electrical field formed in the hologram area 13 is changed, the focal length of the hologram lens 10 can be adjusted from f0 to f1, which is greater than f0, or to f2, which is less than f0.

Here, a principle of varying the focal length of the hologram lens 10 by applying an electrical field to the hologram 13 is as follows.

In a case where a reference beam and a recording beam are radiated onto the holographic plate 11′ made of a holographic material having a refractive index which varies according to an electro-optic effect, so that the reference beam and the recording beam overlap, the reference beam and the recording beam interfere and an interference pattern is recorded on the holographic plate 11′. Thus, the recorded interference pattern is a hologram and an area in which the hologram is recorded is the hologram area 13. Here, the refractive index of a part of the hologram area 13 in which a constructive interference occurs is different from the refractive index of a part of the hologram area 13 in which a destructive interference occurs. Since the holographic plate 11 is made of a material having a refractive index which varies according to an electro-optic effect when an electrical field is applied to the hologram area 13 in which the hologram is recorded, the refractive index of the hologram area 13 varies.

In other words, the difference between the refractive index of the part of the hologram area 13 in which the constructive interference occurs and the refractive index of the part of the hologram area 13 in which the destructive interference occurs varies depending on the strength of the applied electrical field. Due to this, the focal length of the hologram lens 10 varies.

The hologram lens 10, which is a focal adjustable type, may be used in an optical apparatus which includes at least one or more lenses and has a lens system capable of adjusting at least one of a focal point and a magnifying power.

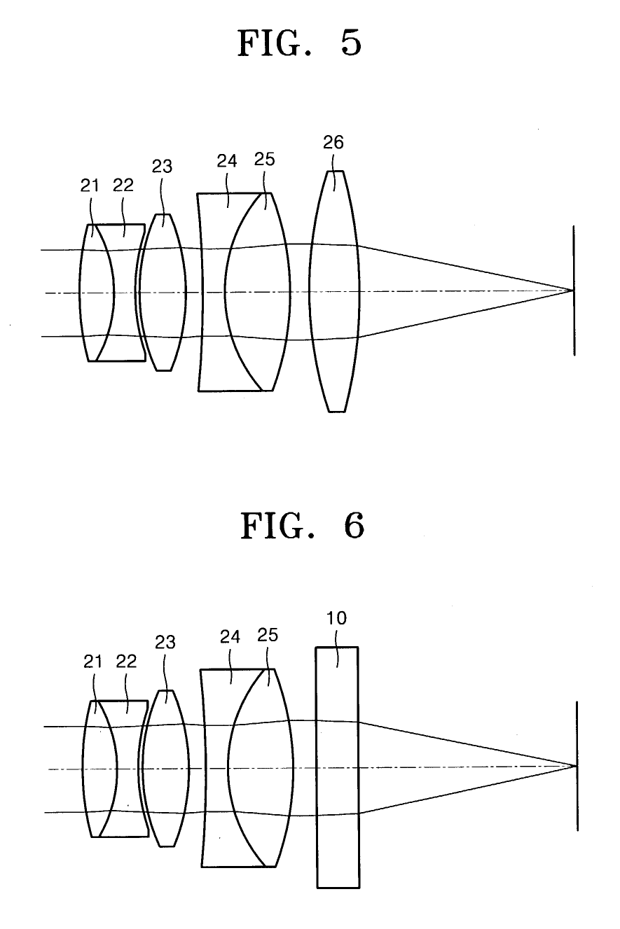

FIG. 5 is a view of a lens system having a plurality of lenses 21 through 26 according to an embodiment of the present invention, and FIG. 6 is a view illustrating an example of using the hologram lens 10 according to the present invention instead of a lens 26 of the plurality of lenses 21 through 26 of the lens system shown in FIG. 5.

As seen in FIGS. 5 and 6, it is possible to use at least one or more hologram lenses 10 according to the present invention in a lens system instead of a general lens.

Here, a focal point and/or a magnifying power of the lens system can be adjusted by adjusting the strength of an electrical field applied to the hologram area 13 of the hologram lens 10. Thus, a lens system having a hologram lens according to the present invention does not have to include an additional moving part for adjusting a focal length.

In other words, comparing the hologram lens 10 shown in FIG. 6 with the lens 26 shown in FIG. 5, the hologram lens 10 may be used instead of a general lens 26 of the lens system having at least one or more lenses. Also, since the hologram lens 10 is a focal adjustable type, it is possible to adjust a focal point and/or a magnifying power of the lens system without an additional mechanical moving part for moving a lens.

Accordingly, the hologram lens 10 may be used in a zoom lens system or a focal adjustable lens system.

The hologram lens 10 according to the present invention may also be used in a compound lens system of a camera or a video camera (e.g., a camcorder), so that a lens system capable of adjusting a focal point without a moving part can be realized.

Furthermore, the hologram lens 10 according to the present invention may be used in an optical pickup of an optical recording and/or reproducing apparatus. In particular, the hologram lens 10 may be used as an objective lens of an optical pickup, which focuses incident light as a light spot on an optical recording medium. In the case where the hologram lens 10 is used as an objective lens of an optical pickup, a magnetic circuit for adjusting the focal position of the objective lens in a focusing direction may be excluded.

Accordingly, in an event that the hologram lens 10 according to the present invention is used as an objective lens, the structure of an actuator for driving the hologram lens 10 can be simplified more than an actuator used for driving an objective lens in a focusing direction and a tracking direction in a general optical pickup. Weight of a moving part for moving the objective lens can also be reduced. Thus, an optical pickup suitable for a high-speed optical recording and/or reproducing apparatus can be realized.

To describe in more detail, as known in the optical pickup-related art field, an actuator for an optical pickup includes a magnetic circuit having a focusing coil and a focusing magnet, and a tracking coil and a tracking magnet in order to drive an objective lens in a focusing direction and a tracking direction. Like the objective lens, a coil part or a magnetic part of the magnetic circuit is installed in a moving part.

Therefore, in a case where the hologram lens 10 according to the present invention is used as an objective lens for an optical pickup, the focusing coil and the focusing magnet may be excluded from the magnetic circuit. Thus, weight of the moving part of the objective lens can be reduced and the structure of the actuator can also be simplified.

Here, the structure of an optical pickup using a hologram lens according to the present invention and an actuator excluding a magnetic circuit for adjusting a focal position in a focusing direction of an objective lens can be fully inferred from an optical pickup structure that is generally known, based on the detailed description of the present invention, by one skilled in the optical pickup-related art field. Thus, the structure of an optical pickup using a hologram lens according to the present invention and the structure of an actuator will not be described here.

As described above, a hologram lens according to the present invention is made of a material having a refractive index which varies according to an electro-optic effect and which records a hologram thereon so that the hologram lens serves as a lens. Thus, in the hologram lens according to the present invention, a focal point can vary depending on the strength of an electrical field applied to a hologram area.

Accordingly, in a case where the hologram lens according to the present invention is used in an optical apparatus having a lens system which includes at least one or more lenses and requires an adjustable focal point and/or a magnifying power, an additional device for moving a lens to vary the focal point is not required.

What is claimed is:

1. A hologram lens comprising;
a holographic plate formed of a material having a refractive index which varies according to an electro-optic effect and having a hologram recorded thereon to serve as a lens; and
first and second electrodes disposed on front and back surfaces of the holographic plate to apply an electrical field to a hologram area of the holographic plate in which at least the hologram is recorded,
wherein a focal point of the hologram lens is adjusted depending on a strength of the electrical field applied to the hologram area.

2. The hologram lens of claim 1, wherein the holographic plate is formed of one selected from the group consisting of a polymer liquid crystal, a dichromated gelatin, a silver-halide emulsion, a photoresist, and a non-linear holographic recording material.

3. The hologram lens of claim 2, wherein the non-linear holographic recording material is one of photopolymer, LiNbO₃, and BSO.

4. An optical apparatus including a lens system having at least one lens and adjusting at least one of a focal point and a magnifying power, the lens system comprising:
a holographic plate formed of a material having a refractive index which varies according to an electro-optic effect and having a hologram recorded thereon to serve as one of said at least one lens; and
first and second electrodes disposed on front and back surfaces of the holographic plate to apply an electrical field to a hologram area of the holographic plate in which at least the hologram is recorded,
wherein a focal point of the one of said at least one lens is adjusted depending on a strength of an electrical field applied to the hologram area.

5. The optical apparatus of claim 4, wherein the holographic plate is formed of one selected from the group consisting of a polymer liquid crystal, a dichromated gelatin, a silver-halide emulsion, a photoresist, and a non-linear holographic recording material.

6. The optical apparatus of claim 5, wherein the non-linear holographic recording material is one of photopolymer, LiNbO₃, and BSO.

7. The optical apparatus of claim 5, wherein the optical apparatus is used in an optical recording and/or reproducing apparatus and a hologram lens including the holographic plate and first and second electrodes is used as an objective lens for focusing incident light as a light spot on an optical recording medium, so that a magnetic circuit for adjusting a focal position of the objective lens in a focusing direction is excluded.

8. The optical apparatus of claim 4, wherein the optical apparatus is used in an optical recording and/or reproducing apparatus and a hologram lens including the holographic plate and first and second electrodes is used as an objective lens for focusing incident light as a light spot on an optical recording medium, so that a magnetic circuit for adjusting a focal position of the objective lens in a focusing direction is excluded.

9. The optical apparatus of claim 5, wherein the lens system is one of a zoom lens system, a focal adjustable lens system, a compound lens system of a camera, and a compound lens system of a video camera.

10. The optical apparatus of claim 4, wherein the lens system is one of a zoom lens system, a focal adjustable lens system, a compound lens system of a camera, and a compound lens system of a video camera.
